(19) United States
(12) Patent Application Publication
(10) Pub. No.: US 2013/0122988 A1
(43) Pub. Date: May 16, 2013

(54) WAGERING GAME HAVING A CONTINUOUS REEL STRIP POPULATING MORE THAN ONE EVALUATION WINDOW

(71) Applicant: WMS Gaming Inc., Waukegan, IL (US)

(72) Inventors: Andrew C. Guinn, Chicago, IL (US); Jeremy M. Hornik, Chicago, IL (US); Joel R. Jaffe, Glenview, IL (US); Jeremie D. Moll, Chicago, IL (US); Jeffry L. Nauman, Yorkville, IL (US); Steven Rosen, Chicago, IL (US)

(73) Assignee: WMS Gaming Inc., Waukegan, IL (US)

(21) Appl. No.: 13/676,772

(22) Filed: Nov. 14, 2012

Related U.S. Application Data
(60) Provisional application No. 61/560,416, filed on Nov. 16, 2011.

(51) Int. Cl. A63F 13/00

(52) U.S. Cl. CPC A63F 13/00
USPC 463/20

(57) ABSTRACT

A gaming system for conducting a wagering game includes at least one input device, at least one display device, and at least one processor. The gaming system further includes at least one memory device that stores a plurality of instructions that, when executed by the at least one processor, cause the at least one processor to operate with the at least one display device and the at least one input device to display a wagering game having an array of symbol positions, the array of symbol positions being populated by a plurality of symbols for indicating a randomly selected outcome, the array of symbol positions forming a plurality of groups of symbol positions, wherein a single reel populates more than one non-adjacent groups of symbol positions.

### CROSS-REFERENCE To RELATED APPLICATION

This application claims the benefit of U.S. Provisional Application No. 61/560,416, filed Nov. 16, 2011, which is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to wagering games having a continuous reel strip populating more than one non-adjacent evaluation window.

### BACKGROUND OF THE INVENTION

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player

### SUMMARY OF THE INVENTION

According to one aspect of the present invention, a gaming system includes at least one input device, at least one display device, and at least one processor. The gaming system further includes at least one memory device that stores a plurality of instructions that, when executed by the at least one processor, cause the at least one processor to operate with the at least one display device and the at least one input device to display a wagering game having an array of symbol positions, the array of symbol positions being populated by a plurality of symbols for indicating a randomly selected outcome, the array of symbol positions forming a plurality of groups of symbol positions, wherein a single reel populates more than one non-adjacent groups of symbol positions.

According to another aspect of the invention, a computer-implemented method in a gaming system includes receiving a wager in response to an input via at least one input device. The method further includes displaying on at least one display device a wagering game having an array of symbol positions, the array of symbol positions being populated by a plurality of symbols for indicating a randomly selected outcome, the array of symbol positions forming a plurality of groups of symbol positions, wherein a single reel populates more than one non-adjacent groups of symbol positions.

According to another aspect of the invention, one or more machine-readable storage media including instructions which, when executed by one or more processors, cause the one or more processors to perform operations includes displaying a wagering game having an array of symbol positions, the array of symbol positions being populated by a plurality of symbols for indicating a randomly selected outcome, the array of symbol positions forming a plurality of groups of symbol positions, wherein a single reel populates more than one non-adjacent groups of symbol positions.

According to yet another aspect of the invention, computer readable storage media is encoded with instructions for directing a gaming system to perform the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an embodiment of the present invention.

FIG. 2 is a schematic view of a gaming system according to an embodiment of the present invention.

FIG. 3 is an image of an exemplary basic-game screen of a wagering game displayed on a gaming terminal, according to an embodiment of the present invention.

FIG. 4A is an image of a game screen including a continuous reel according to one embodiment.

FIG. 4B is an image of a game screen according to another embodiment.

FIG. 4C is an image of a game screen according to yet another embodiment.

FIG. 5 is an image of a game screen including two continuous reels.

FIG. 6 is an image of a game screen including a continuous reel populating three non-adjacent evaluation windows.

FIG. 7 is an image of a game screen according to another embodiment.

FIG. 8A is an image of a game screen according to yet another embodiment.

FIG. 8B is an image of a game screen subsequent to the game screen of FIG. 8A.

FIG. 9A is an image of a game screen including a continuous reel having stretched symbol positions.

FIG. 9B is an image of a game screen including a continuous reel having shrunken symbol positions.

FIG. 10 is an image of a game screen according to another embodiment.

FIG. 11 is an image of a game screen including a continuous reel populating symbol positions of three arrays.

FIG. 12 is an image of a game screen according to another embodiment.

FIG. 13 is an image of a game screen including two intersecting continuous reels.

FIG. 14 is an image of a game screen according to another embodiment.

FIG. 15 is an image of a community-type wagering game.

FIG. 16 is a flowchart for an algorithm that corresponds to instructions executed by a controller in accord with at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

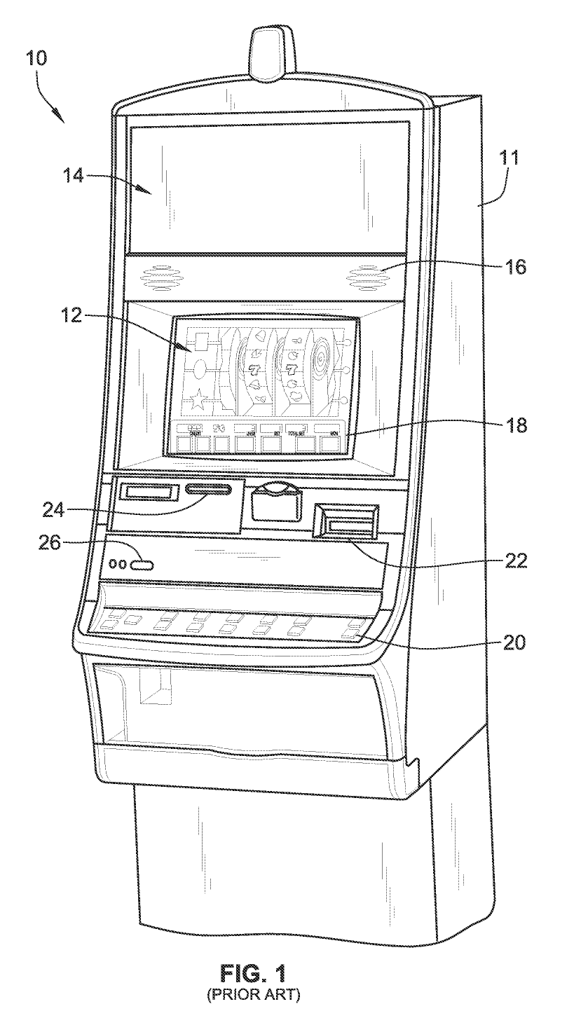

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0062196 and US2010/0234099, which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

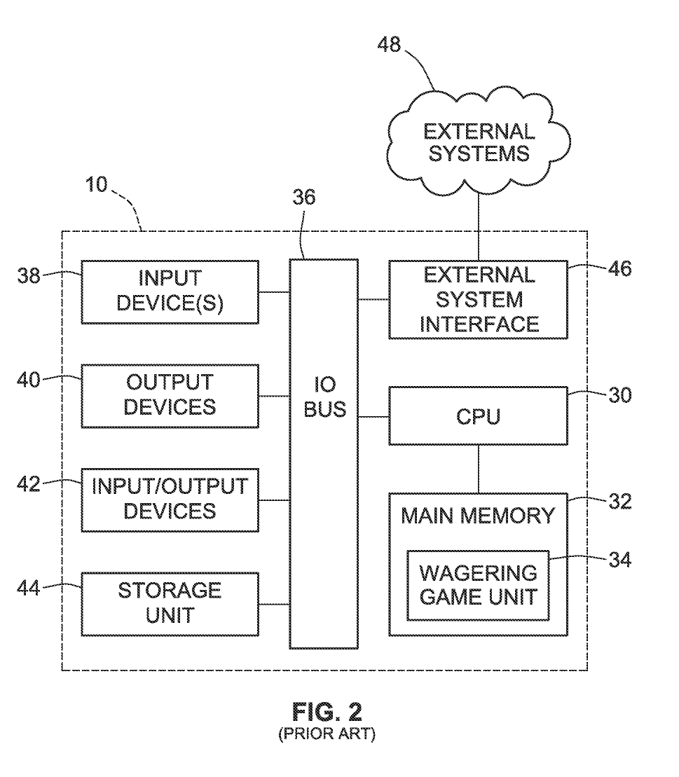

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

According to the embodiments described herein, a single, continuous reel strip displayed on a display of a gaming machine populates more than one non-adjacent evaluation windows or groups of symbol positions of at least one array. For example, the continuous reel may populate more than one column (e.g., columns formed by reels 52 of FIG. 3), row, or a combination thereof. In an embodiment where the groups of symbols are columns, the single reel may populate symbol positions of two columns which are separated by at least one standard reel and are, thus, not adjacent to one another. The continuous reel described herein may be employed during a basic game, a bonus game, or a combination thereof.

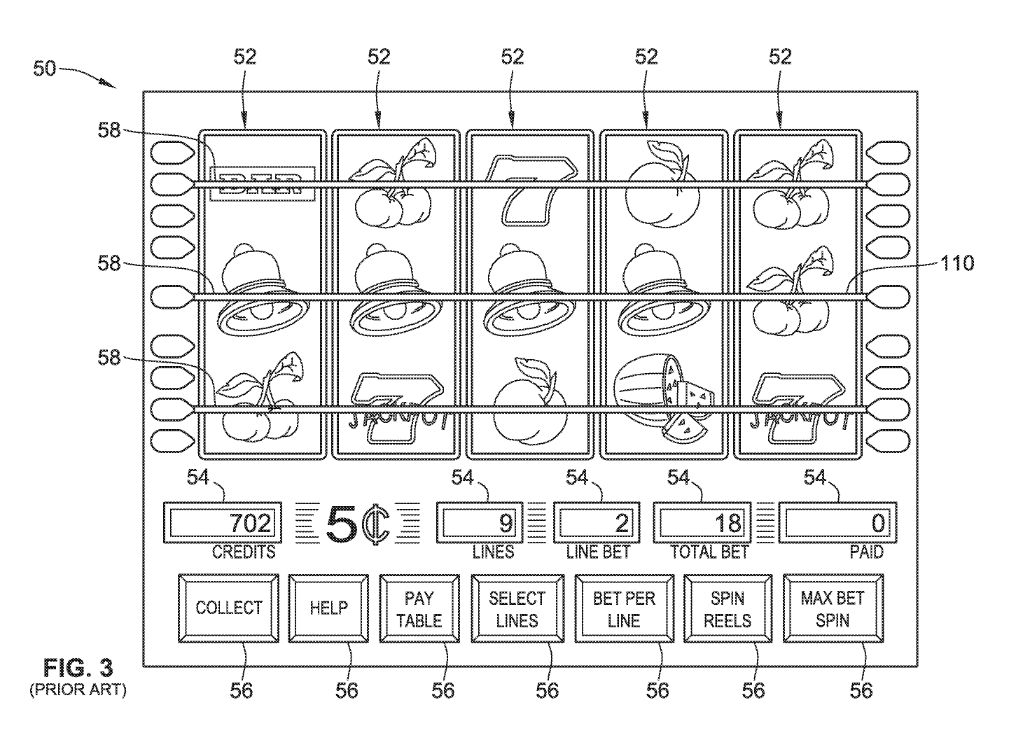

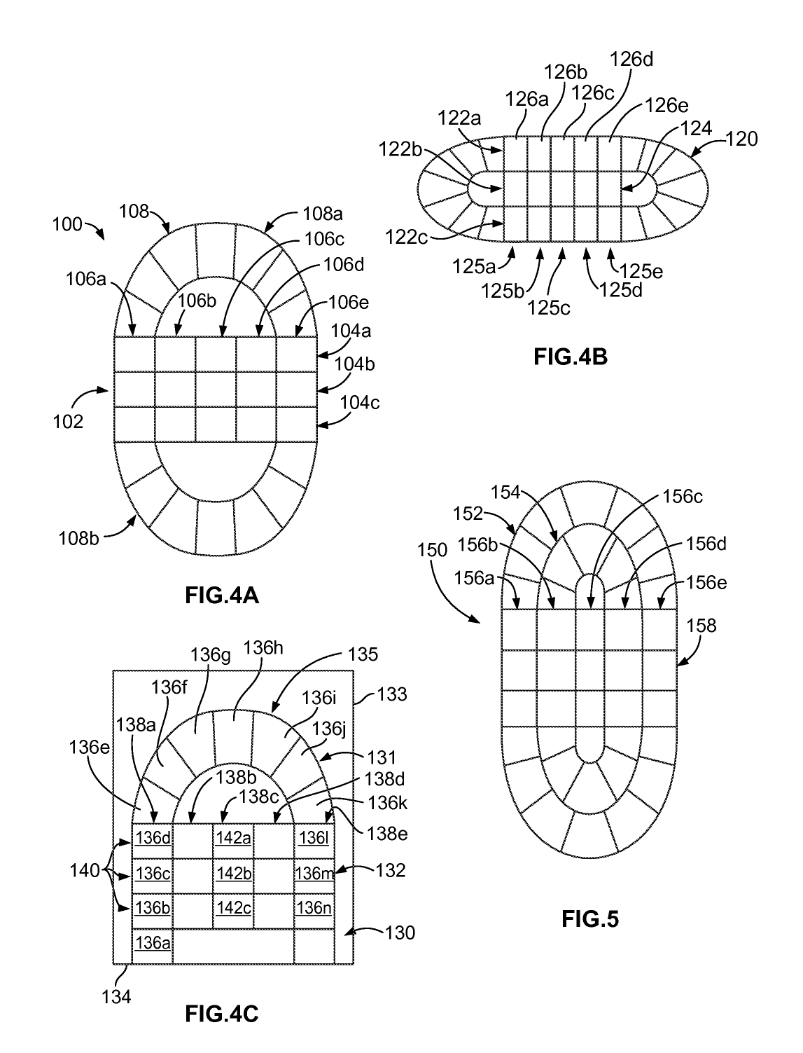

One example of a reel structure 100 according to the embodiments described herein is shown in FIG. 4A. The reel structure 100 includes a standard 3×5 evaluation array 102 including three rows 104a-c and five columns 106a-e. The reel structure 100 further includes a continuous reel 108 having a top portion 108a displayed above the array 102, a bottom portion 108b displayed below the array 102, and a portion populating the first and fifth columns 106a, 106e of the array 102. The columns 106a, 106e populated by the continuous reel 108 are separated, e.g., by at least one standard reel populating the second, third, and/or fourth columns 106b-106d. The continuous reel 108 may rotate or “spin” in a clockwise or counterclockwise direction.

The continuous reels of the embodiments of the present invention are advantageous and desirable for several reasons. Referring to FIG. 4A, for example, allowing the player to see which symbols on the continuous reel 108 are approaching the symbol positions of the first and fifth column 106a, 106c in the array 102 may add anticipation and/or excitement to the player's gaming experience.

Although the continuous reel 108 of FIG. 4A is shown populating the symbol positions of the first and fifth columns 106a, 106b, it is contemplated that any non-adjacent groups of symbols (columns or rows) may be populated by the continuous reel 108. For example, the continuous reel 108 may populate the second and fourth columns 106b, 106d, the first and fourth columns 106a, 106d, or the like. The continuous reel 108 may also populate, e.g., the first, second, and fourth columns 106a, 106b, 106d. In such an embodiment, at least one of the columns populated by the continuous reel 108 (i.e., the fourth column 106d) is not adjacent to at least one of the other columns (i.e., the first and second columns 106a, 106b) populated by the continuous reel 108.

The reels forming the columns of the embodiments described herein may all stop “rotating” at the same time. Alternatively, the reels may stop sequentially. Referring still to FIG. 4A, for example, it is contemplated that the reels of the second, third, and fourth columns 106b, 106c, 106d stop first while the continuous reel 108 continues to spin. This may be desirable so that the player is able to determine what symbols must land in the first and fifth columns 106a, 106e to obtain an award-generating outcome or an enhanced award outcome. Thus, the player's level of anticipation is heightened. In one embodiment, the continuous reel 108 slows down substantially before coming to a stop.

As shown in FIG. 4B, a continuous reel 120 may also or alternatively occupy more than one non-adjacent row 122a-122c in an array 124. In the embodiment shown in FIG. 4B, the continuous reel 120 populates first and third rows 122a, 122c of a 3×5 array 124, which are separated by a second row 122b populated by one or more other reels (e.g., five separate reels each rotating in a vertical direction, independent/single-symbol reels, or the like). The continuous reel 120 may also “weave through” columns 125a-125e of the first and third rows 122a, 122c such that the symbols of the continuous reel 120 occupy less than all of the positions in the first and third rows 122a, 122c. For example, the continuous reel 120 may weave through the first row 122a, going “under” the first column 125a, “over” the second column 125b and populating the symbol position 126b, under the third column 125c, over the fourth column 125d and populating symbol position 126d, and back under the fifth column 125e, such that the symbols of the continuous reel 120 are displayed only in the symbol positions 126b and 126d of the second and fourth columns 125b, 125d.

It is also contemplated that less than the entire continuous reel may be shown on the display at any given time. The remaining portion may be hidden from a player's view. FIG. 4C illustrates a reel structure 130 in which a bottom portion of a continuous reel 131 positioned below an array 132 has been effectively “cut off” from being displayed on a display 133. The bottom portion of the continuous reel 131 is, thus, hidden from a player's view. Therefore, if the reel 131 is rotating in a clockwise direction, the symbols coming up from the bottom 134 of the display 133 into symbol positions 136b-136d of a first column 138a of the array 132 may be randomly generated. In other words, the continuous reel 131 would effectively function as an infinitely-long reel.

In another embodiment illustrated in FIG. 5, a reel structure 150 includes a first and second continuous reel 152, 154, each of which occupy more than one non-adjacent evaluation windows or groups of symbol positions (e.g., columns 156a, 156e and columns 156b, 156d, respectively). In this embodiment, the groups of positions of the array 158 that are occupied by each of the continuous reels 152, 154 are separated by at least one other reel/column.

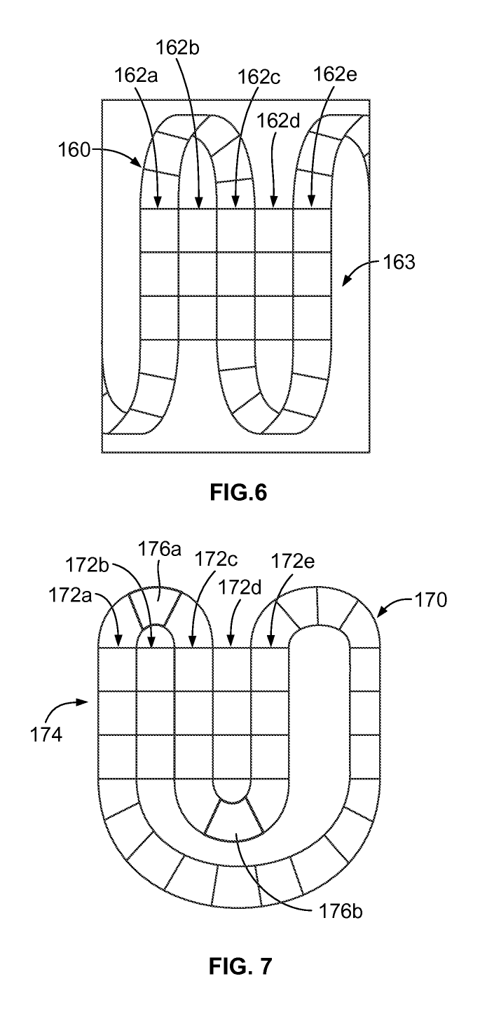

In the embodiment of FIG. 6, a continuous reel 160 populates first, third, and fifth columns 162a, 162c, 162e of an array 163 by curving in a snake-like fashion up through the first column 162a, then down through the third column 162c, and then back up through the fifth column 162e. It is contemplated that the continuous reel 160 may also curve in the opposite direction, e.g., (1) down through the fifth column 162e, then up through the third column 162c, and then back down through the first column 162a, (2) up through the fifth column 162e, then down through the third column 162c, and then back up through the first column 162a, or the like).

The embodiments disclosed herein may also be implemented using 3-dimensional (3-D) reels. In one non-limiting example, each segment of the 3-D reel is cube-shaped, having four sides, each of which may include a symbol that may be displayed on the continuous reel. The plurality of “cubes” may then be linked together to form the 3-D continuous reel. Still referring to FIG. 6, for example, the snake-like continuous reel may be a 3-D reel, shown twisting such that a front side of the 3-D reel goes through the first and fifth columns 162a, 162e, and a back side of the 3-D reel goes through the middle column 162c. Other suitable 3-D reels may also be used with the embodiments described herein.

In some embodiments, the non-array symbols of the continuous reel also contribute to a feature of the wagering game such as, for example, the game outcome. For example, one or more of the non-array symbols may be used to trigger a game functionality, such as a bonus game, a bonus award, a symbol modification, or the like. Moreover, the functionality of symbols of the array corresponding with (e.g., being the same as) the “special” non-array symbols may be altered. Turning to FIG. 7, for example, a continuous reel 170 is shown going through first, third, and fifth columns 172a, 172c, 172e of an array 174. The continuous reel 170 of FIG. 7 includes at least one special symbol position, or window, located outside of the array 174. In the illustrated embodiment of FIG. 7, the continuous reel 170 includes a first special window 176a and a second special window 176b. In this exemplary embodiment, if the symbols landing in the respective special windows 176a, 176b match (are the same symbol), then like symbols in the array 174 are treated as WILD symbols. In another embodiment, if a multiplier lands in one or more of the special window 176a, 176b, that multiplier is automatically applied to the outcome of the wagering game.

Although FIG. 7 shows the continuous reel 170 populating the first, third, and fifth columns 172a, 172c, 172e of an array 174, in another embodiment, the continuous reel may populate, e.g., the second and fourth columns 172b, 172c. In such an embodiment, the continuous reel may loop around the outside of the first and fifth columns 172a, 172e.

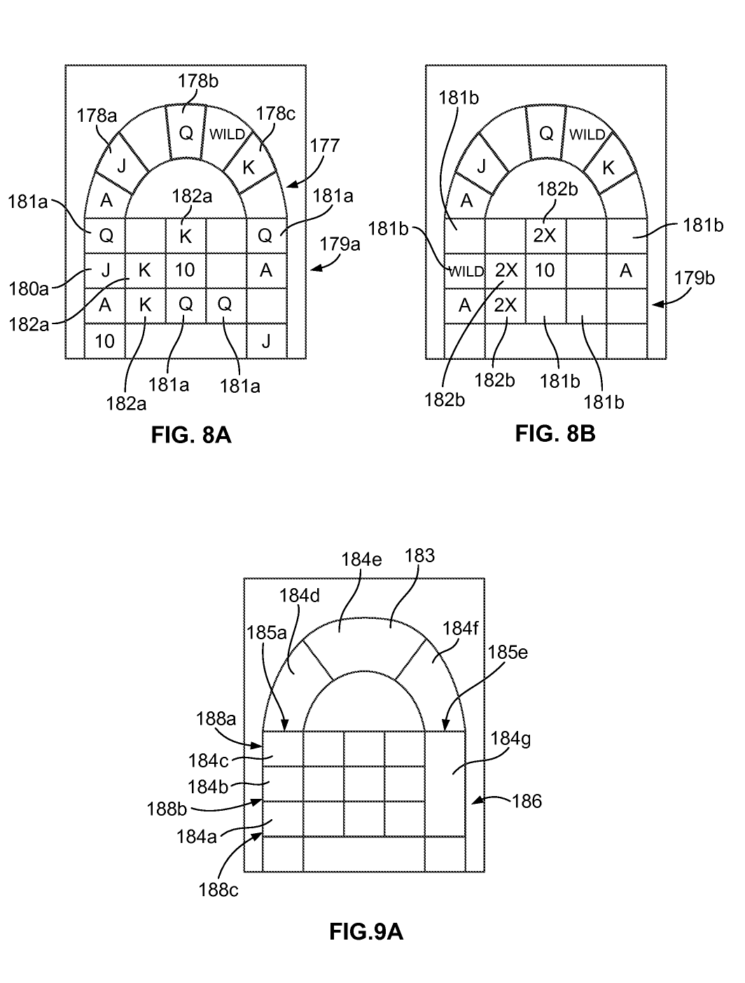

According to another example shown in FIGS. 8A-8B, a continuous reel 177 includes special windows 178a, 178b, 178c positioned above an array 179a, 179b. In one example, “special” symbols appearing in each of the first, second, and third windows 178a-178c designate which symbols of the array 179a will become WILD symbols, blank/nonpaying symbols, and a 2× multiplier, respectively. Thus, as shown in FIGS. 8A-8B, because a “J” symbol lands in the first window 178a, all of the “J” symbols 180a of the array 179a (FIG. 8A) become WILD symbols 180b in the modified array 179b (FIG. 8B). Likewise, the “Q” symbols 181a of the array 179a (FIG. 8A) become blank symbols 181b of the modified array 179b (FIG. 8B), and the “K” symbols 182a of the array 179a (FIG. 8A) become 2× multipliers 182b of the modified array 179b (FIG. 8B). Although not shown in FIGS. 8A-8B, like symbols of the continuous reel 177 may also or alternatively be modified. If the symbols in two or more of the windows 178a-c are the same, the better outcome may prevail (e.g., the symbols may become WILD symbols or multipliers), the worst outcome may prevail (the symbols may become blank symbols), or another outcome or feature may be triggered.

Still referring to FIGS. 8A-8B, it is contemplated that the appearance of a predetermined symbol(s) in one or more of the special windows may trigger other features of the wagering game such as, but not limited to, awarding scatter-pay awards, multiplying existing award values, awarding additional awards or bonus spins, or the like. In another embodiment, a player is awarded the initial wager amount per each appearance of one or more of the “special” symbols in the array.

It should be noted that, in the aforementioned embodiments, the symbols of the continuous reel that populate each of the evaluation windows of the array are positionally dependent on one another. That is, the symbols populating the first column 138a of FIG. 4A are necessarily X-number of symbol positions either in front of or behind the symbols that populate the symbol positions of the fifth column 138e, depending on the direction of rotation of the continuous reel 131. In other words, because all of the symbols of the continuous reel 131 are positioned a predetermined amount of symbol positions from one another, each time the series of symbols in symbol positions 136b, 136c, and 136d populate the first column 138a of the array 132, symbols in symbol positions 136l, 136m, and 136n will necessarily populate the fifth column 138e of the array 132.

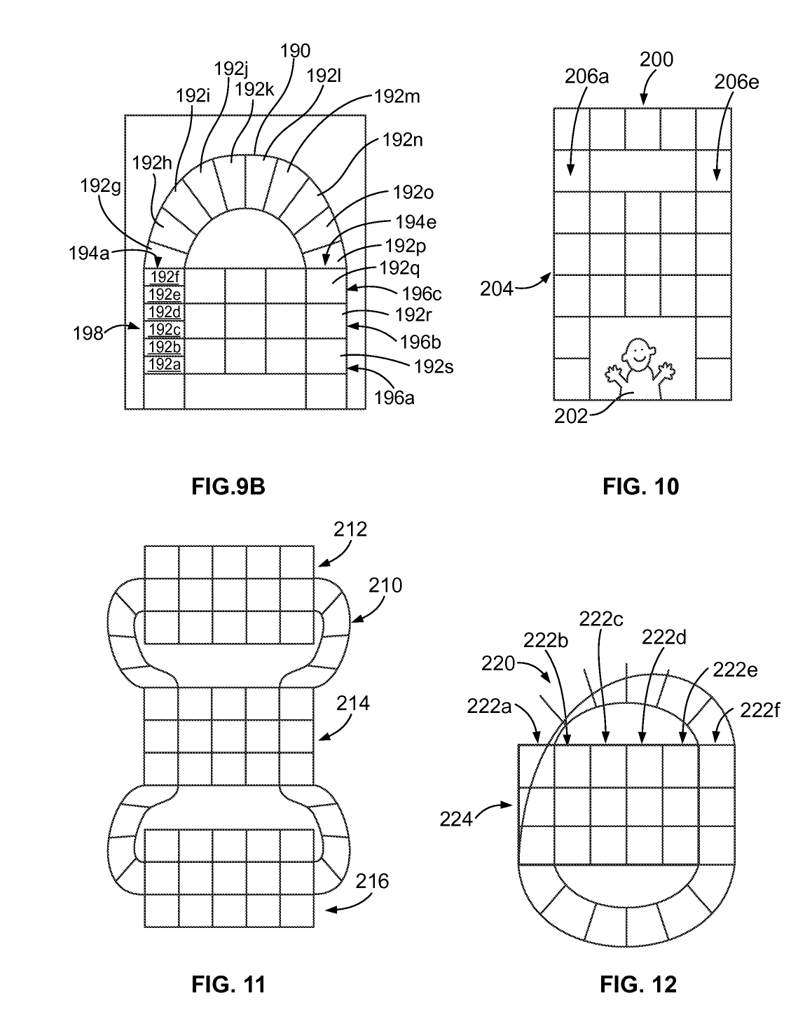

It is contemplated, however, that this positional dependency may be circumvented. For example, referring to FIG. 9A, a continuous reel 183 rotates in a clockwise direction until symbols in the symbol positions 184a, 184b, 184c of the continuous reel 183 land in and populate the first column 185a. The continuous reel 183 then continues to rotate in the clockwise direction during which the symbol positions 184d, 184e, 184f, 184g “stretch,” or become larger than the standard symbol positions (i.e., symbol positions 184a-184c). Thus, a single symbol occupying the “stretched” symbol position 184g occupies the entire fifth column 185e of an array 186 and effectively functions as three separate like symbols, each occupying one row 188a, 188b, 188c of the array 186. In one embodiment, the continuous reel 183 may “spring back” to having all standard-sized symbol positions, thereby changing which symbols of the continuous reel 183 occupy the fifth column 185e. The array 186 may then be reevaluated for new winning outcomes. In another embodiment, the symbol positions 184d, 184e, 184f above the array 186 stretch, but three separate symbols/symbol positions of the continuous reel 185 populate each row 188a-188c of the fifth column 185e of the array 186. It is also contemplated that two or the rows of the array 186 may be occupied by a single symbol in a “stretched” symbol position while the remaining row may be occupied by a symbol in a standard-sized symbol position.

It is also contemplated that, instead of (or in addition to) “stretched” symbol positions, the symbol positions may also “shrink,” as shown, for example, in FIG. 9B. In FIG. 9B, a continuous reel 190 rotates in a clockwise direction until symbols in symbol positions 192q, 192r, 192s of the continuous reel 190 populate the fifth column 194a. Thereafter, the continuous reel 190 continues to rotate in the clockwise direction, during which the symbol positions 190a-190p of the continuous reel 190 “shrink,” becoming, for example, half the size of standard-sized symbol positions. Thus, symbol positions 192e and 192f occupy the first row 196a, symbol positions 192c and 192d occupy the second row 196b, and symbol positions 192a and 192b occupy the third row 196c of the array 198. The player's chances of achieving an award are, thus, increased because each row 196a-c of the first column 194a of the array 198 includes two symbols, each of which can contribute to a winning outcome on a payline associated therewith.

The embodiments of FIGS. 9A and 9B add flexibility to the wagering game, since the symbol positions of the first columns 185a, 194a occupied by the continuous reels 183, 190 are not positionally dependent upon the symbol positions of the fifth columns 185e, 194e occupied by the continuous reel 183, 195. Thus, a player does not necessarily know which symbols will land in, for example, the fifth column 185e of FIG. 9A based on which symbols land in the first column 185a, as the symbols landing in the fifth column 185e are not necessarily dictated by (i.e., positionally dependent upon) the symbols landing in the first column 185a. These embodiments may also be desirable in that the player may first focus on which symbols land in the first column 185a, and then shift his or her focus to which symbols land in the fifth column 185e, rather than try to watch both columns 185a, 185e at the same time. Thus, the “stretched” and “shrunken” reels may add yet another level of excitement and anticipation to the player's gaming experience. Different “weights” invisible to the player can also be placed on different sections of the continuous reel to assist in determining which portion(s) of the continuous reel will “stretch,” which will “shrink,” etc.

The embodiments of the present invention may also or alternatively include a cascading feature. Referring back to FIG. 4C, for example, a triggering condition may cause one or more of the symbols in the upper portion 135 of the continuous reel 131 (i.e., the portion above the array 132) to “drop down” into the array 132. The triggering condition may include a gap in the array 132 caused by a cascade within the array 132 itself (e.g., three adjacent like symbols which are removed from the array 132).

In another example, if the symbols in “special” symbol positions 136g and 136i match, the symbol in the symbol position 136h drops down into the array 132. The dropped-down symbol may populate the symbol position 142a of the third column 138c of the array 132, thereby pushing the other symbols of the third column 138c down one symbol position. Thus, the symbol previously occupying the symbol position 142a may drop down into symbol position 142b, the symbol previously occupying the symbol position 142b may drop down into symbol position 142c, and the symbol previously occupying the symbol position 142c may be removed from the array 132. Thereafter, the array 132 may be reevaluated for additional winning outcomes.

After the dropped-down symbol has cascaded/is removed from the continuous reel 131, one side of the continuous reel 131 may shift upward to fill the gap left by the dropped-down symbol. In one embodiment, the controller randomly selects which side of the continuous reel 131 shifts, thereby adding another level of anticipation. Thus, for example, the left side of the continuous reel 131 may shift upwards (i.e., clockwise) such that each symbol of the symbols positions 136a-g moves up one symbol position to fill the gap left by dropped-down symbol of symbol position 136h. Thus, the symbol occupying symbol position 136d moves out of the array 132 (into the symbol position 136e), and a new symbol (previously occupying the symbol position 136a) enters the array 132 (into the symbol position 136b). The array 132 may then be reevaluated for additional winning outcomes. In another embodiment, after the dropped-down symbol has cascaded/is removed from the continuous reel 131, one of the adjacent symbol positions 136g, 136i “stretches” to fill the gap left by the dropped-down symbol.

Referring again to FIG. 4A, according to another embodiment, the second column 106b, third column 106c, and fourth column 106d may remain stationary, e.g., during a bonus game, while the continuous reel 108 rotates a predetermined number of times. Each time the continuous reel 108 comes to a stop, the array 102 may be reevaluated to determine whether any additional winning outcomes have been achieved. The rotation of the continuous reel 108 may be accomplished by way of a “nudging” feature. In embodiments including a nudging feature, after the array is evaluated for winning outcomes, the continuous reel (e.g., continuous reel 108 of FIG. 4A) or a portion thereof may be “nudged” one or more symbol positions. The array 102 may then be reevaluated for additional winning outcomes. The nudging feature may be repeated any suitable (e.g., predetermined) number of times. The number of symbol positions, the direction, and/or the number of times that the continuous reel 108 is nudged may vary (e.g., among bonus spins, based on the wager amount, etc.).

In one embodiment, the continuous reel is nudged a certain number of symbol positions in a first direction (e.g., two spaces clockwise), then a certain number of symbol positions in the opposite direction (e.g., four spaces counter-clockwise), etc. in a “combination-lock” fashion. The array may be reevaluated between nudges for additional winning outcomes.

In another embodiment, symbols or groups of symbols (e.g., columns) in the array may “swap” positions. In one example, if the array 102 of FIG. 4A includes the same symbols in the first column 106a and the fifth column 106e, the symbols in the fifth column 106e may “swap” positions with the respective symbols of the second column 106b. The reels associated with columns 106c-e may then be respun to determine whether any additional winning outcomes have been achieved. The player then has a greater chance of achieving a winning symbol combination during the respin, since the first and second (stationary) columns 106a, 106b already include matching symbols.

Turning now to FIG. 10, another embodiment in which symbols on a continuous reel 200 may be varied is illustrated. In the illustrated embodiment, a “monkey” character 202 may add a symbol(s) (e.g., a WILD symbol) into or remove a symbol(s) from the continuous reel 200. In one embodiment, the monkey 202 holds symbols on the continuous reel 200 back (prevents them from advancing in a standard clockwise/counterclockwise fashion) with one hand and adds symbols into the continuous reel 200 with the other hand. The monkey 202 may be positioned beneath an array 204, as shown in FIG. 10 such that the symbols added to/taken from the continuous reel 200 affect the outcome on both the first and the fifth columns 206a, 206e of the array 204. Alternatively or additionally, the monkey 202 may be positioned above the array 204 such that the symbols added to/taken from the continuous reel 200 affect only the outcome of one of the first and fifth column 206a, 206e. In other words, the continuous reel 200 of FIG. 10 may periodically be “broken” (by the monkey 202) to have symbols either added thereto or taken therefrom. It is also contemplated that more than one monkey 202 may be positioned in more than one location relative to the array 204 and continuous reel 200. Instead of adding new symbols, the monkey 202 may add, for example, one or more WILD symbols over or in addition to an existing symbol/symbol position in the continuous reel 200.

It is also contemplated that a continuous reel may occupy symbol positions of more than one array of symbols. For example, as shown in FIG. 11, symbols positioned on a continuous reel 210 are used to populate portions of a top array 212, a middle array 214, and a bottom array 216. Thus, the continuous reel 210 occupies non-adjacent evaluation windows of more than one array 212, 214, 216.

Referring now to FIG. 12, a continuous reel 220 populates a first column 222a of an array 224 and forms what appears to be an alternate sixth column 222f adjacent to the fifth column 222e. The alternate reel 222f is not included in the array 224, (i.e., is not used to determine winning outcomes). Rather, the symbols of the alternate reel 222f may be compared to the symbols of the fifth reel 222e. If the symbols of the alternate reel 222f would form a better outcome (e.g., provide a higher payout) than those of the fifth reel 222e, the symbols of the fifth reel 222e may “swap” positions with those of the alternate reel 222f.

Still referring to FIG. 12, in another embodiment, the array 224 itself may horizontally “shift,” thereby varying which columns are included in the array 224. Thus, if a first array including the first, second, third, fourth, and fifth columns 222a-e yields a lesser award than a second array including the second, third, fourth, fifth, and alternate sixth columns 222b-e, then the second evaluation array may be used to determine the player's award amount.

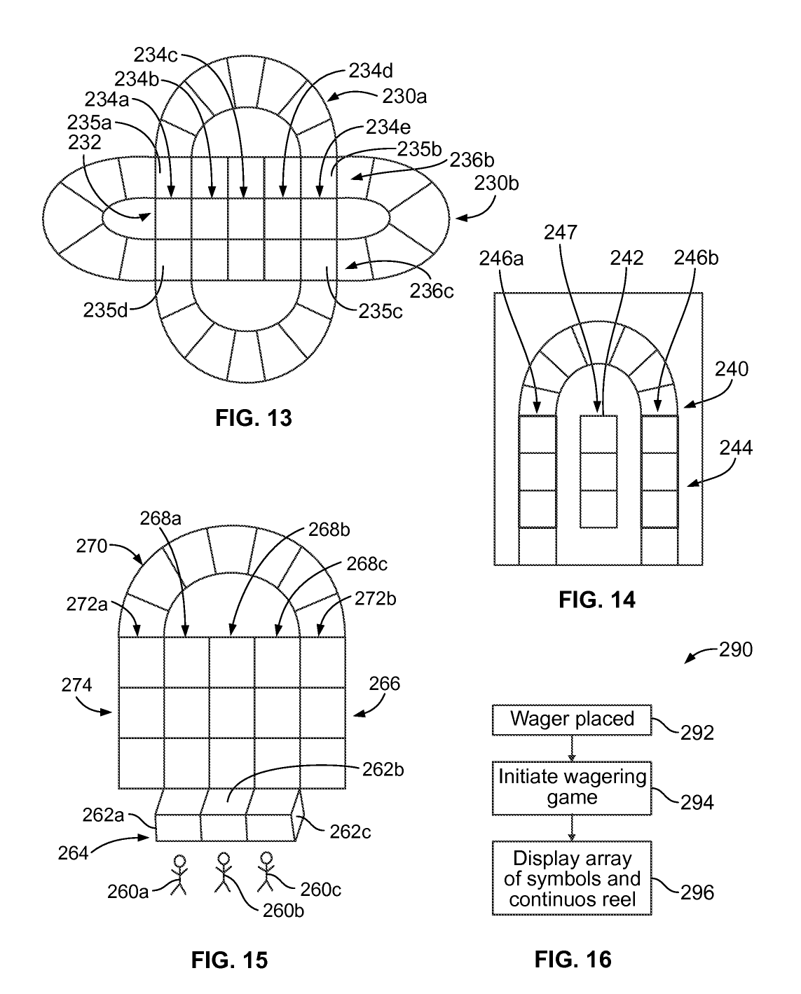

Referring now to FIG. 13, two continuous reels 230a, 230b are shown populating portions of a single array 232. The continuous reels 230a, 230b may be interwoven (as discussed, for example, with respect to FIG. 4C) in any suitable manner. For example, the first continuous reel 230a may populate the first and fifth columns 234a, 234e of the array 232, and the second continuous reel 230b may populate the top and bottom rows 236a, 236c of the second, third, and fourth columns 234b-d. In this example, the second continuous reel 230b effectively weaves “underneath” the first and fifth columns 234a, 234e.

Still referring to FIG. 13, in another embodiment, the first continuous reel 230a populates the first and fifth columns 234a, 234e of the array 232, and the second continuous reel 230b populates all of the symbol positions of the top and bottom rows 236a, 236c of the array 232. Overlapping symbol positions 235a-d may, for example, have a “special” functionality. In one embodiment, each of the overlapping symbol positions 235a-d includes two symbols—one from the first continuous reel 230a and a second from the second continuous reel 230b—each of which can contribute to a winning outcome on a payline associated therewith.

FIG. 14 shows one embodiment in which a continuous reel 240 is used in conjunction with a mechanical reel 242 to form a 3×3 array 244. The array 244 includes first and third columns 246a, 246b populated by the continuous reel 240 and a second middle column 247 formed from the mechanical reel 242. It is contemplated that the mechanical reel 242 may also be a video reel that functions like a mechanical reel.

The embodiments described herein may also be applied to community-type wagering games. As shown in FIG. 15, for example, each player 260a-c plays a respective wagering game 262a-c in a bank of gaming machines 264. The bank of gaming machines 264 includes a community display 266 associated therewith. Upon triggering a bonus event, one column or reel of an array displayed on each player's wagering game 262a-c is displayed in a respective column 268a-c of the community display 266. In other words, a column of the first player's 260a wagering game 262a is duplicated in the corresponding column 268a of the community display 266. Likewise, a column of the second player's 260b wagering game 262b is duplicated in the corresponding column 268b of the community display 266, and a column of the third player's 260c wagering game 262c is duplicated in the corresponding column 268c of the community display 266. The community display 266 also includes a continuous reel 270, portions of which populate first and fifth columns 272a, 272b of the community display 266. The combination of columns 272a, 268a-268c, 272b form a 3×5 array 274, which may then be evaluated for winning outcomes. The winning outcomes, if any, may be awarded to all of the players 260a-c.

A player skill component may be added to any of the embodiments described herein. For example, the player may be given the ability to stop a continuous reel from spinning In one embodiment, the continuous reel is “elastic” such that the continuous reel is guaranteed to stop within four symbol positions of when the player stops the reel. Thus, the continuous reel may advance up to four positions ahead of the point at which the player stopped the reel, or the reel may reverse up to four positions back.

FIG. 16, described by way of example above, represents one algorithm 290 that corresponds to at least some instructions executed by the CPU 30 in FIG. 2 to perform the above described functions associated with the disclosed concepts. By way of non-limiting example, the exemplary algorithm 290 of FIG. 16 includes, at block 205, a wager being placed or otherwise confirmed (e.g., via bill validator 22, coin acceptor, information reader/writer 24, or other input device), where play of the wagering game is initiated at block 294. At block 296, the at least one display device displays a wagering game having an array of symbol positions. The array of symbol positions is populated by a plurality of symbols for indicating a randomly selected outcome. The array of symbols positions form a plurality of groups of symbol positions, wherein a single reel populates more than one non-adjacent groups of symbol positions.

Each of these embodiments and obvious variations thereof is contemplated as falling within the spirit and scope of the claimed invention, which is set forth in the following claims.

What is claimed is:

1. A gaming system comprising:
at least one input device;
at least one display device;
at least one processor; and
at least one memory device that stores a plurality of instructions that, when executed by the at least one processor, cause the at least one processor to operate with the at least one display device and the at least one input device to
display a wagering game having an array of symbol positions, the array of symbol positions being populated by a plurality of symbols for indicating a randomly selected outcome, the array of symbol positions forming a plurality of groups of symbol positions, wherein a single reel populates more than one non-adjacent groups of symbol positions.

2. The gaming system of claim 1, wherein the plurality of groups include a plurality of columns and a plurality of rows.

3. The gaming system of claim 1, wherein the non-adjacent groups are separated by at least one other group of symbol positions.

4. The gaming system of claim 1, wherein the non-adjacent groups are columns, the columns being separated by at least one standard reel.

5. The gaming system of claim 1, wherein the wagering game further comprises a second reel, the second reel occupying more than one non-adjacent groups of symbol positions.

6. The gaming system of claim 1, wherein a portion of the single reel is hidden from view.

7. The gaming system of claim 1, wherein at least one symbol position populated by the single reel may be enlarged, the enlarged symbol position populating more than one symbol position of the array.

8. The gaming system of claim 1, wherein the single reel includes non-array symbol positions displayed on the at least one display device.

9. The gaming system of claim 8, wherein at least one of the displayed non-array symbols is a special non-array symbol, the functionality of one or more symbols of the array corresponding with the one or more special non-array symbol being altered.

10. A computer-implemented method in a gaming system, comprising:
receiving a wager in response to an input via at least one input device;
displaying on at least one display device a wagering game having an array of symbol positions, the array of symbol positions being populated by a plurality of symbols for indicating a randomly selected outcome, the array of symbol positions forming a plurality of groups of symbol positions, wherein a single reel populates more than one non-adjacent groups of symbol positions.

11. The computer-implemented method of claim 10, wherein the plurality of groups include a plurality of columns and a plurality of rows.

12. The computer-implemented method of claim 10, wherein the non-adjacent groups are separated by at least one other group of symbol positions.

13. The computer-implemented method of claim 12, wherein the non-adjacent groups are columns, the columns being separated by at least one standard reel.

14. The computer-implemented method of claim 10, wherein the wagering game further comprises a second reel, the second reel occupying more than one non-adjacent groups of symbol positions.

15. The computer-implemented method of claim 10, wherein a portion of the single reel is hidden from view.

16. The computer-implemented method of claim 10, further comprising enlarging at least one symbol position populated by the single reel, the enlarged symbol position populating more than one symbol position of the array.

17. The computer-implemented method of claim 10, wherein the single reel includes non-array symbol positions displayed on the at least one display device.

18. The computer-implemented method of claim 17, wherein at least one of the displayed non-array symbols is a special non-array symbol, the method further comprising altering a functionality of one or more symbols of the array corresponding with one or more special non-array symbols.

19. The computer-implemented method of claim 17, further comprising cascading at least one symbol positioned within at least one non-array symbol positions into the array of symbols.

20. The computer-implemented method of claim 17, further comprising adding one or more non-array symbols into the single reel.

21. One or more machine-readable storage media including instructions which, when executed by one or more processors, cause the one or more processors to perform operations comprising:
displaying a wagering game having an array of symbol positions, the array of symbol positions being populated by a plurality of symbols for indicating a randomly selected outcome, the array of symbol positions forming a plurality of groups of symbol positions, wherein a single reel populates more than one non-adjacent groups of symbol positions.
